(19) United States
(12) Patent Application Publication
(10) Pub. No.: US 2004/0244421 A1
(43) Pub. Date: Dec. 9, 2004

(54) Method for making a lens molding die and method for manufacturing a lens

(75) Inventors: Kinya Kato, Osakasayama-shi (JP); Toshiyuki Imai, Ikoma-shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/669,044

(22) Filed: Sep. 23, 2003

(30) Foreign Application Priority Data
Jun. 3, 2003 (JP) 2003-157770

(51) Int. Cl. B29D 11/00

(52) U.S. Cl. 65/26; 65/374.11; 65/374.13; 264/219; 264/220; 264/2.5

(57) ABSTRACT

A method for making a lens molding replica die for molding a lens made of glass or a synthetic resin comprises the steps of: (1) making a master die having a reference surface; (2) forming a separating film on the master die; (3) forming an SiC film on the reference surface; (4) machining a surface of the die base member into a prescribed shape and machining the SiC film into a shape in conformity of the surface of the die base member; (5) bonding a die base member onto the SiC film; and (6) separating the SiC film bonded onto the die base member from the master die.

This application is based on the application No. 2003-157,770 filed in Japan Jun. 3, 2003, the entire content of which is hereby incorporated by reference.

### BACKGROUND OF THE INVENTION

1. Field of the Invention

The present invention relates to a method for making a lens molding die for molding a lens made of glass or a synthetic resin. In particular, the present invention relates to a method for making a replica die. Furthermore, the present invention relates to a method for manufacturing a lens by the use of such a die.

2. Description of the Prior Art

High accuracy of the shape of an optical surface has been recently required for an optical element made of glass for an optical pickup. A ceramic die for use in molding the optical element needs to be machined with higher accuracy in a short time. Particularly, an objective lens for a blue optical pickup has a markedly convex shape with a peripheral inclination angle of an optical surface of 50° or more in many cases.

A die for molding a convex lens having a peripheral inclination angle of 50° or more is made of a hard and brittle material (normally composed of WC) having heat resistance and a deep concave shape, and therefore, it is difficult to achieve highly accurate finishing by general grinding from the viewpoint of a tool layout.

The viewpoint of a tool layout signifies that only a small and fine tool can be used since a tool (i.e., a grindstone) needs to be located inside of a surface to be ground in grinding a concave shape, resulting in reduction of the rigidity of the tool or an increase in abrasion, so as to degrade machining accuracy.

Japanese Patent Application Laid-open No. 2002-3,226 discloses a replica die having a molding surface (a freely curved polyhedron) formed by not grinding but transferring and a method for fabricating the same. However, the replica die disclosed in Japanese Patent Application Laid-open No. 2002-3,226 cannot always be resistant against use at high temperature, and further, is not suitable for mass production.

On the other hand, Japanese Patent Application Laid-open No. 2002-53,327 discloses a molding die for an optical part made of glass having a surface shape of a fine groove or the like, such as a hologram optical element or a micro lens, and a method for fabricating the same. The molding die is fabricated by the following steps comprising: making an original die having a predetermined surface shape; fabricating a replica die by depositing ceramic particles on the original die by vapor deposition; and making a glass molding die by separating the replica die from the original die. The original die is made of a material which can be readily machined, such as aluminum or copper. However, when a material having a large coefficient of thermal expansion such as aluminum or copper is used as the original die, there is a fear of deformation of the original die caused by high temperature at the time of the deposition. Additionally, in order to provide strength enough to endure pressurization at high temperature when a lens is molded, a thick die is needed. In the case of a die for a lens having a great deviation from a plane, it is necessary to deposit the ceramic particles on the original die for a long period of time, so as to provide a sufficient thickness. However, there has been arisen a problem of the need of a very long period of time to fabricate the replica die.

### SUMMARY OF THE INVENTION

An object of the present invention is to enable a plurality of replica dies to be fabricated with high accuracy in a short time, and further, to provide a method for fabricating a replica die for molding a lens, which is excellent in heat resistance and has a highly hard molding surface.

Another object of the present invention is to provide a method for stably manufacturing a lens having few variation in shape with high accuracy.

In order to achieve the above-described objects, according to the present invention, a method for making a lens molding die comprises the steps of: providing a master die having a reference surface, the reference surface being equivalent to a lens surface that is to be molded by the lens molding die; forming an SiC film on the reference surface; bonding a die base member onto the SiC film, said die base member and said SiC film constituting the lens molding die; and separating the lens molding die from the master die.

In another aspect according to the present invention in order to achieve the above-described objects, a method for manufacturing a plurality of lenses comprises the steps of: providing a master die having a reference surface, the reference surface being equivalent to a lens surface that is to be molded by the lens molding die; forming an SiC film on the reference surface; bonding a die base member onto the SiC film, said die base member and said SiC film constituting the lens molding die; separating the lens molding die from the master die; molding a lens material between an upper die and a lower die under pressure, at least one of the upper die and the lower die being the lens molding die. A plurality of lenses are manufactured by repeating the step of molding a lens material between an upper die and a lower die under pressure.

### BRIEF DESCRIPTION OF THE DRAWINGS

These and other objects, advantages and features of the invention will become apparent from the following description thereof taken in conjunction with the preferred embodiments with the reference to the accompanying drawings in which:

FIG. 1 is a cross-sectional view illustrating a method for fabricating a replica die for molding a lens in order of process in a lens fabricating method in a preferred embodiment;

FIG. 2 is a cross-sectional view illustrating a fabricating process of the replica die illustrated in FIG. 1 in order of process in a modification;

FIGS. 3A and 3B are cross-sectional views illustrating a glass molding method in order of process in a lens fabricating method in a preferred embodiment, respectively; and

FIG. 4 is a cross-sectional view illustrating a plastic lens molding method in order of process in a lens fabricating method in a preferred embodiment.

### DETAILED DESCRIPTION OF THE PREFERRED EMBODIMENTS

A method for making a lens molding die and a method for manufacturing a lens in preferred embodiments according to the present invention will be described below in reference to the accompanying drawings.

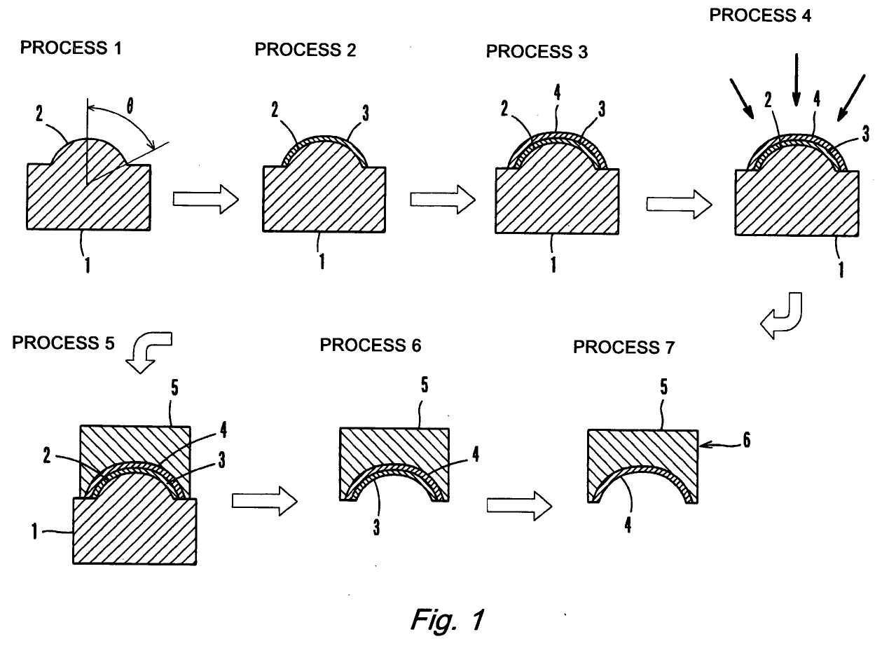

FIGS. 1 illustrates a method for making a lens molding replica die in a preferred embodiment according to the present invention.

First of all, in a process 1, a master die 1 is made. A material is selected from heat resistant materials such as SiC (silicon carbide), WC (tungsten carbide) and cermet, and further, a reference surface 2 having a convex shape is machined. Here, WC includes not only pure tungsten carbide but also hard metals incorporating mainly tungsten carbide obtained by blending and sintering metal such as Ni or Co. Cermet is a composite material including ceramic and metal, which is a composite alloy including mainly titanium carbide (TiC) sintered with iron group metal (such as Fe, Co or Ni).

The reference surface 2 is equivalent to the lens surface of an optical lens as a final product. The reference surface 2 is an aspheric surface having a peripheral inclination angle θ of, for example, 50° or more, and further, its radius is, for example, about 2.7 mm. Here, the reference surface 2 is not always aspheric. The reference surface 2 is machined into a mirror surface having a surface roughness Rz of 20 nm or less. Here, the surface roughness Rz represents a maximum height, and it is defined under the JIS (abbreviating Japanese Industrial Standards) B0601-2001. The reference surface 2 can be processed by various kinds of methods as long as the required surface roughness can be achieved. In the present preferred embodiment, grinding by the use of a grindstone was adopted. When the reference surface 2 is machined, a bottom surface of a block of master die material was used as a processing standard. The bottom surface of a block of master die can become a processing standard in a subsequent process.

Since the reference surface 2 of the master die 1 is formed into a convex shape, there is no restriction of a layout of a tool, unlike the case of a concave shape, and thus, the reference surface 2 can be machined into a mirror surface with high accuracy even if the peripheral inclination angle θ is 50° or more. The heat resistant material is used as the master die 1 in consideration of sufficient resistance against as high a temperature as several hundred degrees which is a film forming condition of a separating carbon film 3 or an SiC film 4 in post-processes. Consequently, it is possible to prevent any deformation of the reference surface 2.

Incidentally, various kinds of heat resistant material other than the above-described SiC, WC and cermet may be used as the material for the master die 1: for example, glassy carbon may be used. With the glassy carbon, the reference surface 2 is readily machined, and further, the formation of the separating carbon film 3, which is conducted in a following process, can be omitted.

Next in a process 2, the separating carbon film 3 is formed on the reference surface 2 of the master die 1 by deposition. Specifically, the master die 1 was cleaned, and then, was set inside of a vacuum chamber, which was evacuated down to a degree of vacuum of 2×10⁻⁵ Pa, and subsequently, a carbon film was formed on the reference surface 2 in a thickness of 30 angstrom by a PVD (abbreviating Physical Vapor Deposition) method in the state in which the master die 1 is heated at 400° C. Here, the separating film is not limited to a carbon film, but may be a metallic film. For the metallic film materials that are readily etched are preferable. The materials include, for example, aluminum, copper, silver, nickel, cobalt, palladium, platinum and titanium.

Subsequently in a process 3, the SiC film 4 is formed on the separating carbon film 3 by deposition. Specifically, SiC was deposited on the separating carbon film 3 in a thickness of several hundred μm by a CVD (abbreviating Chemical Vapor Deposition) method. If the SiC film 4 is formed by sintering, texture becomes porous, and therefore, glass intrudes into and fused to pores when a lens is molded. In contrast, such an inconvenience never occurs in the deposition film. Since the SiC film 4 used as the molding surface of the lens is excellent in heat resistance and has high hardness, it is suitable for molding a glass lens.

Thereafter in a process 4, the surface of the SiC film 4 is shaped by grinding or cutting in conformity of the shape of a die base member 5 to be bonded. It is preferable that a surface to be bonded of the die base member 5 should be spherical or flat. Since a spherical or flat surface is readily machined with high accuracy, the surfaces of the base member 5 and the SiC film 4 can be readily machined with high accuracy. The surface of the SiC film 4 was formed into a spherical shape in conformity of the curvature radius of the bonded surface of the base member 5, and further, was finished with a surface roughness Ra of 10 nm or less. Here, the surface roughness Ra represents an arithmetic average height, and is defined under the JIS B0601-2001.

Next in a process 5, the die base member 5 is bonded to the SiC film 4. As an adhesive, a carbon adhesive, a ceramic adhesive or the like are used. Specifically, a ceramic adhesive including mainly alumina having a coefficient of thermal expansion of about 4.3×10⁻⁶/K was used.

It is preferable that a material having the same coefficient of thermal expansion as that of the SiC film 4 should be used as the materials for the die base member 5 and the adhesive. The selection of the above-described material can prevent any generation of a thermal stress between the die base member 5 and the SiC film 4, thereby preventing any deformation of the molding surface or any separating-off of the bonded surface. As the material for the die base member 5, for example, SiC, WC or Si₃N₄ (silicon nitride) are used.

SiC has a coefficient of thermal expansion of about 4.5×10⁻⁶/K; WC, 5 to 7×10⁻⁶/K; and Si₃N₄, about 3.5×10⁻⁶/K . Here, WC is a sintered component, and therefore, its coefficient of thermal expansion may be slightly varied according to its particle size or composition.

Subsequently in a process 6, a tensile stress or a shearing stress or the like is applied to the separating carbon film 3, so that the SiC film 4 bonded to the die base member 5 is separated from the master die 1. While the die base member 5 is clamped, the die base member 5 is pulled and separated off with the exertion of force in a vertical direction with respect to the center of the reference surface 2. The die base member 5 is readily separated off since the adhesiveness of the separating carbon film 3 with respect to the master die 1 is weak. In the case where the separating film is a metallic film, the metallic film is dissolved by etching, and then, is separated off. Separating methods include a mechanical method by using the stress and a chemical method by etching or the like, as described above.

Thereafter in a process 7, the separating carbon film 3 is removed. Specifically, the carbon film 3 adhering to the SiC film 4 was removed by ashing for 5 minutes.

Through the above-described processes 1 to 7, there can be provided a replica die 6 having the concave surface of the SiC film 4 as the molding surface. The replica die 6 is used as a die when a glass or plastic lens is pressed. In this case, the concave surface of the SiC film 4 serves as the molding surface.

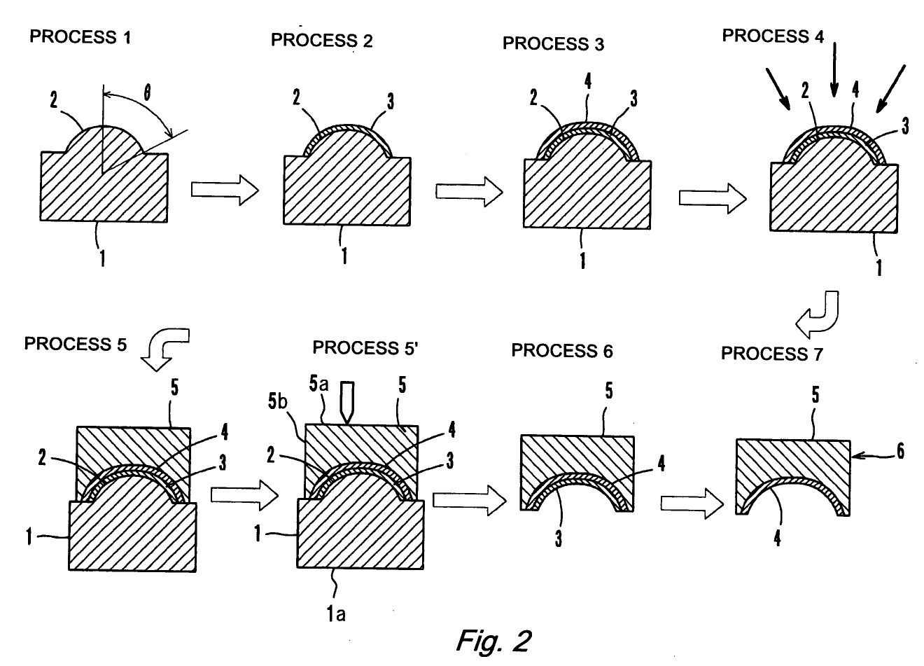

Furthermore, in the process for fabricating the replica die, the inclination accuracy of a lens to be molded can be further enhanced by adding a process 5′ illustrated in FIG. 2. In the process 5′, an upper surface 5a and/or a side surface 5b of the bonded die base member 5 is machined. The upper surface 5a and/or the side surface 5b serves as a reference surface when a die is incorporated when a lens is molded. In the case where the die base member 5 is bonded to the SiC film 4, the performance of the lens is degraded if the die base member 5 is bonded with an inclination with respect to the center axis of the SiC film 4, which corresponds to the optical axis of the lens. In order to prevent any degradation of the performance of the lens, the upper surface 5a and/or the side surface 5b are machined in such a manner as to form a desired angle with respect to a bottom surface 1a of the master die 1. It is preferable that the upper surface 5a should be parallel to the bottom surface 1a. In addition, it is preferable that the side surface 5b should be perpendicular to the bottom surface 11a. It is understood that the reference surface 2 is machined in reference to the bottom surface 11a of the master die 1 in the process 1. In this manner, the addition of the process 5′ can further enhance the accuracy of the die.

In the above-described product method, the plurality of replica dies 6 can be fabricated in a short time by simply providing the single master die 1 and by repeating the process 2 to 7. Since the reference surface 2 of the master die 1 is convex in the present preferred embodiment, the reference surface 2 can be machined with high accuracy, thus enhancing the accuracy of the molding surface of the SiC film 4 in the replica die 6.

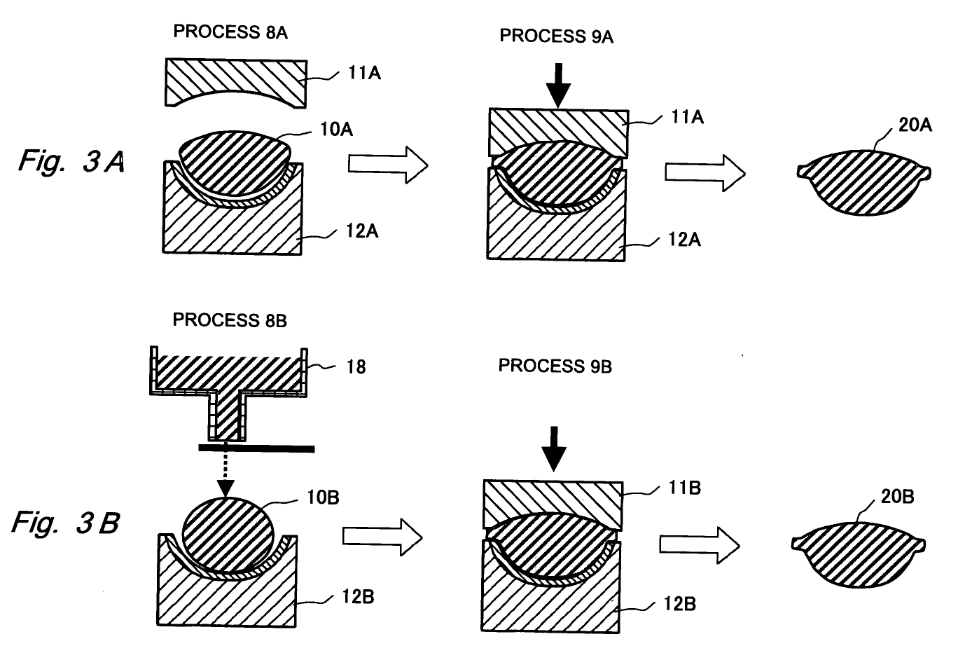

Next, a method for molding a glass lens will be explained below in reference to FIGS. 3A and 3B. The method for molding a glass lens is roughly classified into two groups: (A) a reheating method and (B) a dropping method. First, explanation will be made on (A) the reheating method (see FIG. 3A).

In a process 8A, a glass material 10A is held between a pair of upper and lower dies, and then, it is heated up to a desired temperature. The glass material 10A has substantially the same shape as that of a molded lens, and is substantially the same in weight and volume as those of the molded lens. Either one of the upper die 11A and the lower die 12A is the replica die 6 fabricated through the above-described processes 1 to 7. It is desirable that both of the upper die 11A and the lower die 12A should be fabricated through the above-described processes 1 to 7. The glass material 10A is heated up to a glass softening point or higher, which is a moldable temperature, by a heater, not illustrated. Moreover, the upper die 11A and the lower die 12A are heated up to a desired temperature. These temperatures depend on the glass material, and are set to optimum temperatures.

Next in a process 9A, either one or both of the upper die 11A and the lower die 12A are moved in a direction in which the interval between the upper die 11A and the lower die 12A becomes narrow, so as to be brought into contact with the glass material 10A, followed by molding under pressure (in FIG. 3A, the upper die 11A moved downward). The resultant molding body is cooled, thus fabricating a lens 20A. The plurality of lenses can be manufactured with one/a pair of replica die(s) by repeating the steps 8A to 9A.

On the other hand, explanation will be made on (B) the dropping method (see FIG. 3B). The dropping method is excellent in efficiently fabricating a fine lens.

In a process 8B, a fused glass 10B is dropped or moved on a lower die 12B. In FIG. 3B, the fused glass material 10B is dropped from a glass sump 18 under a predetermined condition. The lower die 12B is the replica die 6 fabricated through the above-described processes 1 to 7, and it is heated up to a predetermined temperature. Here, an upper die 11B, although not illustrated in the process 8B, also is heated up to a predetermined temperature.

Next, in a process 9B, either one or both of the upper die 11B and the lower die 12B are moved in a direction in which the interval between the upper die 11B and the lower die 12B becomes narrow, so as to be brought into contact with the glass material 10B, followed by molding under pressure (in FIG. 3B, the upper die 11B is moved downward). The resultant molding body is cooled, thus fabricating a lens 20B. The plurality of lenses can be manufactured with one/a pair of replica die(s) by repeating the steps 8B to 9B.

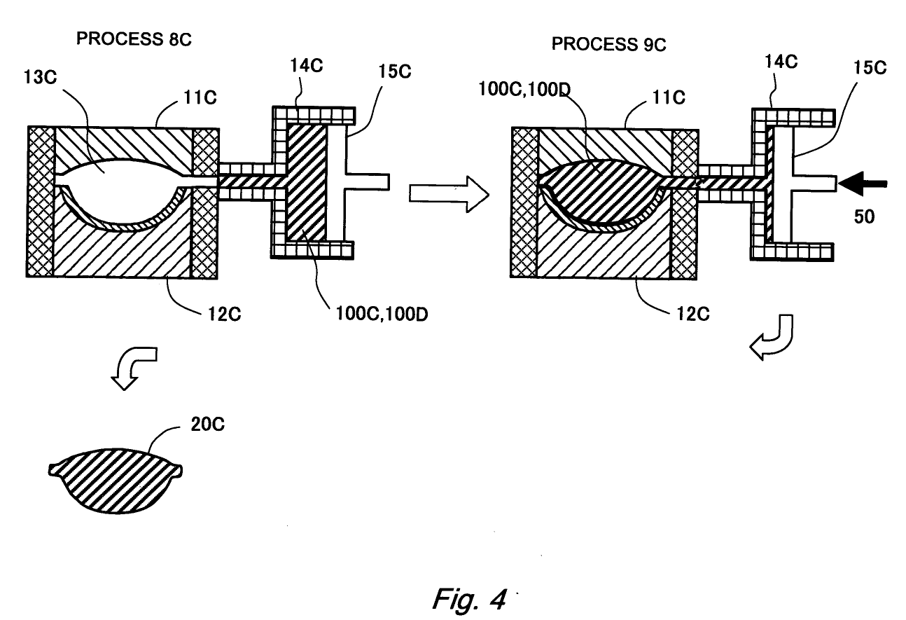

Subsequently, a plastic lens fabricating method will be explained in reference to FIG. 4. FIG. 4 illustrates a plastic lens injection molding method.

In a process 8C, a thermoplastic material 100C or a thermosetting plastic material 100D is heated and fused.

Next in a process 9C, the plastic material 100C (or 100D) is injected and filled under high pressure into a cavity 13 inside of a mold, defined by an upper die 11C and a lower die 12C, followed by solidifying or hardening. In the process 9C in FIG. 4, there is schematically illustrated the state in which the plastic material 100C (or 100D) reserved in a cylinder 14 is injected and filled into the cavity 13C by the motion of a piston 15 in a direction indicated by an arrow 50. The resultant molding body is taken out, thus fabricating a plastic lens 20C. The plurality of plastic lenses can be manufactured with one/a pair of replica die(s) by repeating the step 8C to 9C.

The lens manufactured through the above-described processes has uniform variations in shape even if a different die is used, thereby providing the lens with stable accuracy. This is because when the reference surface 2 of the master die 1 is fabricated with high accuracy, many dies can be readily fabricated with substantially the same accuracy.

In the case of the glass molding, high temperature is liable to shorten the lifetime of the die. In particular, since higher temperature is needed in the case where the accuracy is required, the lifetime of the die is liable to become shorter. It requires much time for repairing or re-fabricating the die. In contrast, in the above-described glass molding method, many dies can be fabricated in a short time with high accuracy, thus solving the problem of the lifetime of the die.

It is to be understood that the lens molding replica die fabricating method and the lens manufacturing method according to the present invention are not restricted to the particular preferred embodiments given above, and that various modifications and alterations can be added thereto without departing from the scope of the present invention.

In particular, various materials for the master die, the separating film, the die base member and various kinds of adhesive between the SiC film and the die base member may be used in addition to those illustrated in the above-described preferred embodiments. Moreover, the details of the shape or structure of the master die or the die base member are arbitrary. Although the reference surface of the master die has been formed into the convex shape, it may be naturally formed into a concave shape. Furthermore, the die illustrated in the above-described preferred embodiments is not limited to the die for the optical pickup.

What is claimed is:

1. A method for making a lens molding die comprising the steps of:
(a) providing a master die having a reference surface, the reference surface being equivalent to a lens surface that is to be molded by the lens molding die;
(b) forming an SiC film on the reference surface;
(c) bonding a die base member onto the SiC film, said die base member and said SiC film constituting the lens molding die; and
(d) separating the lens molding die from the master die.

2. The method as claimed in claim 1, further comprises a step of forming a separating film on the master die between the step (a) and the step (b).

3. The method as claimed in claim 2, wherein the separating film is a carbon film.

4. The method as claimed in claim 3, wherein the carbon film is formed by PVD method.

5. The method as claimed in claim 3, further comprises a step of removing the carbon film by ashing after the step (d).

6. The method as claimed in claim 2, wherein the separating film is a metallic film that can be etched.

7. The method as claimed in claim 1, further comprises steps of machining a surface of the die base member into a prescribed shape and machining the SiC film into a shape in conformity of the surface of the die base member between the step (b) and the step (c).

8. The method as claimed in claim 1, wherein the SiC film and the die base member are bonded to each other via a ceramic adhesive or a carbon adhesive.

9. The method as claimed in claim 1, wherein the SiC film is formed by CVD method.

10. The method as claimed in claim 1, wherein the master die is made of SiC or a hard metal including mainly WC.

11. The method as claimed in claim 1, wherein the master die is made of grassy carbon.

12. The method as claimed in claim 1, wherein the die base member is made of any one of SiC, Si₃N₄, a cermet, or a hard metal including mainly WC.

13. The method as claimed in claim 1, wherein a reference surface of the master die is convex shape.

14. The method as claimed in claim 13, wherein a maximum peripheral inclination angle of the reference surface is 50 degrees or more.

15. The method as claimed in claim 3, further comprises a step of machining an upper surface and/or a side surface of the die base member with reference to a bottom surface of the master die between the step (c) and the step (d).

16. A method for manufacturing a plurality of lenses comprising the steps of:
(a) providing a master die having a reference surface, the reference surface being equivalent to a lens surface that is to be molded by the lens molding die;
(b) forming an SiC film on the reference surface;
(c) bonding a die base member onto the SiC film, said die base member and said SiC film constituting the lens molding die;
(d) separating the lens molding die from the master die;
(e) molding a lens material between an upper die and a lower die under pressure, at least one of the upper die and the lower die being the lens molding die,
wherein a plurality of lenses are manufactured by repeating the step (e).

17. The method as claimed in claim 16, wherein the lens material is a glass material, and wherein the step (e) further comprises the steps of:
(1) holding the glass material between the upper die and the lower die;
(2) heating each of the glass material, the upper die and the lower die up to a prescribed temperature,
before molding the lens.

18. The method as claimed in claim 16, wherein the lens material is a fused glass material, and wherein the step (e) further comprises the step of (1) dropping or placing the fused glass material on the lower die before molding the lens.

19. The method as claimed in claim 16, wherein the lens material is a plastic material and, in the step (e), the plastic material is injected and filled under pressure into a cavity enclosed by the upper die and the lower die.

20. The method as claimed in claim 16, further comprises a step of forming a separating film on the master die between the step (a) and the step (b).
